(19) United States
(12) Patent Application Publication
(10) Pub. No.: US 2025/0326547 A1
(43) Pub. Date: Oct. 23, 2025

(54) Container Cover and Assembly Thereof

(71) Applicant: Detectamet Limited, Pocklington (GB)

(72) Inventor: Sean Ronald Smith, Richmond, VA (US)

(21) Appl. No.: 18/644,899

(22) Filed: Apr. 24, 2024

(30) Foreign Application Priority Data
Jul. 17, 2023 (GB) 6296820
Jul. 17, 2023 (GB) 6296821
Apr. 19, 2024 (GB) 2405557.6

(51) Int. Cl. B65D 65/12; B65D 65/42; B65D 65/46

(52) U.S. Cl. CPC B65D 65/12; B65D 65/42; B65D 65/466; B65D 2565/381

(57) ABSTRACT

A cover apparatus for covering an opening of a container such as an open topped container, known as a tote bin or dump buggy, for the reception of perishables or foodstuffs therein, the cover apparatus comprised of a flexible sheet material and includes first and second folded portions respectively located adjacent to opposing edges of, and co-planar with, the remainder of the said cover apparatus. The folded portions are movable to a partially unfolded position to contact with an adjacent side wall of the container such that the opening of the container is substantially covered by the remainder of the cover apparatus and the folded portions including welds or seals to form a chamber or pouch when at least partially unfolded. The cover apparatus can include materials which allow the cover apparatus, or a fragment thereof, to be rendered detectable by metal and/or X-ray detection apparatus.

The invention to which this application relates is to a cover for a container and, in particular, but not necessarily exclusively, to a detectable cover for a container such as an open topped container for the reception of perishables or foodstuffs therein to be transported within a warehouse, treatment facility, production facility and/or the like. The containers may be portable so as to be carried by a user or, more typically, include movement means such as castor wheels and the containers of this form are also known as “totes” or “dump buggies”.

The use of this type of container to locate perishable goods and transport the same between different locations, for example, within a production or distribution facility, is well-known. The containers are typically comprised of sidewalls and a base defining a cavity for the reception of the goods to be transported therein and accessible via an opening. The containers typically include movement means such as castors so that they may be manoeuvred about the facility in which they are located with relative ease by a user.

When located within the container, the goods are exposed to the environment in which the container is located via the opening of the same. Typically while efforts are made to ensure that the environment is sterile or the conditions of the same are monitored so as to reduce the risk of contamination of the goods, safety standards often dictate that the opening in the containers is provided with a cover while in transit or storage so as to reduce the risk of dust or other contaminants contacting the goods as they are located within and transported about the facility. This is particularly the case for foodstuffs, medications or the like.

It is known to apply a rigid covering for the containers that provides a tight seal with the sidewalls of the same. These rigid coverings are configured for use with a specific geometry of container and are unsuitable for use with containers of varying geometry. Furthermore, the rigid coverings must be disposed if damaged by cracks or the like, at a relatively high cost to the facility managers.

An alternative to the rigid covering is to provide a sheet material, such as cellophane, across the opening of the containers. This sheet material is relatively cheap to manufacture and is disposable after use, preventing the need to decontaminate the coverings after repeated use. However, the sheet material is often difficult to apply to the container opening to adequately cover the same. It is also known to provide sheet material coverings with a predefined geometry and including predetermined folded portions to allow a user of the coverings to locate the cover with the containers. However, these covers are unsuitable for use with different containers with openings with even relatively small variations in geometry but in order to ensure that the cover remains in position it has conventionally been the belief that the fit has to be relatively tight to ensure that that the cover does not fall into the product held in the container. Furthermore, if a sheet material or a fragment thereof becomes dislodged from the container opening and comes into contact with and/or becomes part of the goods located within the container, the cover or fragment themselves become contaminants of the same and represent a risk of causing damage to the manufacturing equipment and/or a risk to the health of the end consumer of the product containing the contaminating cover or fragment thereof.

An aim of the present invention is therefore to provide a covering for a container for the location of consumable goods therein, wherein the covering is suitable for different containers with varying profiles and is detectable by a detecting apparatus to reduce the likelihood that goods contaminated by the covering are undetected and allowed to be transported from the facility in which the containers are located to the end consumer.

In a first aspect of the invention there is provided a cover apparatus for an opening of a container, the said cover apparatus comprised of a flexible sheet material and including first and second folded portions respectively located adjacent to opposing edges of, and co-planar with, the remainder of the said cover apparatus, and each said folded portion capable of being at least partially unfolded to be moved, when the cover apparatus is located over the opening, to a position to contact with an adjacent side wall of the container such that the opening of the container is substantially covered by the remainder of the cover apparatus and wherein the said folded portions of the cover apparatus are retained so as to be substantially co-planar with the remainder of the cover apparatus and when the said respective folded portions are at least partially unfolded, to form a chamber or pouch, by the provision of first and second seals or welds located at opposing ends of each respective folded portion.

In one embodiment the flexible sheet material includes one or more detectable materials as an integral part thereof that render the cover apparatus detectable by X-ray and/or metal detection apparatus when in range thereof so as to allow the presence of the cover apparatus, or a fragment of the cover apparatus greater than a predetermined size, to be detectable.

In one embodiment the detectable material includes particles of a metal or a metal alloy of a form which is capable of detection by metal detection apparatus.

In addition, or alternatively, the detectable material includes any or any combination of barium, magnetite and/or iodine to render the cover apparatus capable of detection by X-ray detection apparatus.

In one embodiment the detectable material is located and mixed within the flexible sheet material at the time of forming the flexible sheet material. In another embodiment, the flexible sheet material is seeded with the detectable material.

In one embodiment the density of the detectable material which is included in the flexible sheet material is selected with respect to the predetermined size of fragment of the cover apparatus which is desired to be detectable when in a predetermined range of detection apparatus.

Typically the predetermined size of the fragment of the cover apparatus is 1 cm² and the detection range is up to 1 metre from the detection means of the detection apparatus.

In one embodiment the said first and second seals or welds are substantially parallel to each other, and perpendicular to fold lines of the folded portion such that the first and second seals or welds and folded portion define the said pouch or chamber.

In this embodiment, the first and second seals or welds define a single pouch or chamber formed at each of said opposing edges of the cover by the respective folded portion of the flexible sheet material. This provides the advantage that only one pouch or chamber must be checked and/or cleaned of debris, contamination, or the like for each folded portion.

In one embodiment the seals or welds are located at opposing ends of the folded portion and the depth of the folded portion is predetermined to suit the geometry of the range of container sizes with which the cover apparatus is designed to be located. Typically, the geometry of the apparatus is such that the apparatus is located with a container by friction fit.

In one embodiment the thickness of the flexible sheet material is between 34 and 70 microns. Preferably, the flexible sheet material is at least 60 microns thick when it is desired that the cover is to be provided to be reusable one or more times and/or to ensure that the cover is of a thickness so as to be resistant to possible tearing or damage caused by the metal particles located within the sheet material to render the same detectable by metal detection apparatus. included with the sheet material.

In one embodiment the cover apparatus is provided in a colour associated with a particular indication, such as the origin or destination locations for a container, the contents of a container, the time in which a cover apparatus was located with a container.

In one embodiment the flexible sheet material is formed of a polymer. Preferably the flexible sheet material is formed of low density polyethylene (LDPE).

In one embodiment, the flexible sheet material is formed by blowing polymer pellets into a film. Typically, the detectable material is interspersed with the polymer pellets prior to the blowing.

In one embodiment, the flexible sheet material is compostable and/or biodegradable.

In one embodiment a series of cover apparatus is provided in a roll supply and the respective cover apparatus are defined by lines of weakening formed across the roll supply so that the leading cover apparatus can be detached for use by tearing a line of weakening.

In a further aspect of the invention there is provided a container and cover apparatus assembly, the assembly including a container with sidewalls, a base and an opening for the placement of goods therethrough, and a cover apparatus comprised of a flexible sheet material and including at least first and second folded portions for location along respective opposing sidewalls of the container such that a remainder of the cover apparatus substantially extends across the opening of the container, wherein when the said first and second folded portions are at least partially unfolded they form a chamber or pouch by the provision of first and second seals or welds located at opposing ends of each respective folded sheet material portion.

In one embodiment the flexible sheet material includes one or more detectable materials as an integral part thereof that are detectable by X-ray and/or metal detection apparatus so as to allow the presence of the cover apparatus, or a fragment of the cover apparatus greater than a predetermined size, to be detectable by metal and/or X-ray detection apparatus.

Typically the container is for the location of produce or ingredients, such as foodstuffs, therein and wherein the container is movable so as to transport the located foodstuffs. In this way, the cover apparatus suitably conceals the located foodstuffs from the environment in which the container is moved, preventing dust or other contaminants from coming into contact with the foodstuffs. The detectable material of the cover apparatus reduces the likelihood that the covering or a fragment thereof greater than a predetermined size contaminates the foodstuff itself as the same is detectable by detecting means and may be removed from the foodstuff before it is transported to the end location and/or the foodstuff may be disposed. The flexible sheet material folded portions allow the cover apparatus to be moved from a substantially flat, storage condition to an in use condition in which the folded portions are at least partially unfolded so as to exert a friction location of the cover apparatus with the adjacent sidewall of the container and act to retain the cover in position on the container whilst also allowing the relatively swift and simple removal of the cover apparatus after use and be moved for disposal or re-use.

Specific embodiments of the invention are now described with reference to the accompanying drawings wherein:

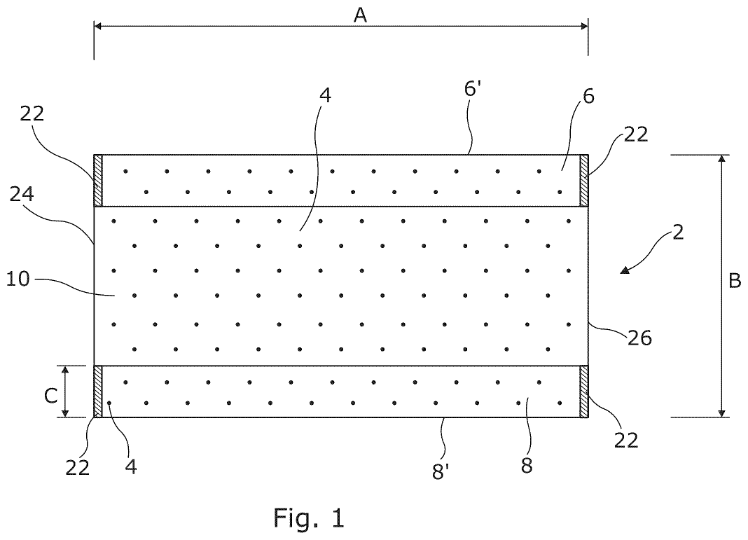

FIG. 1 illustrates a plan view of a cover apparatus in accordance with one embodiment of the invention;

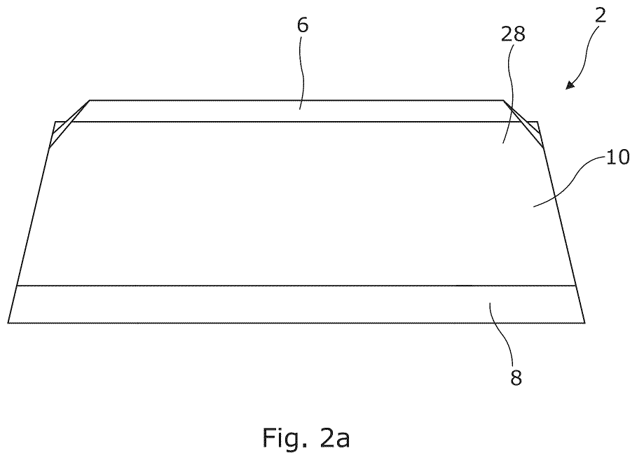

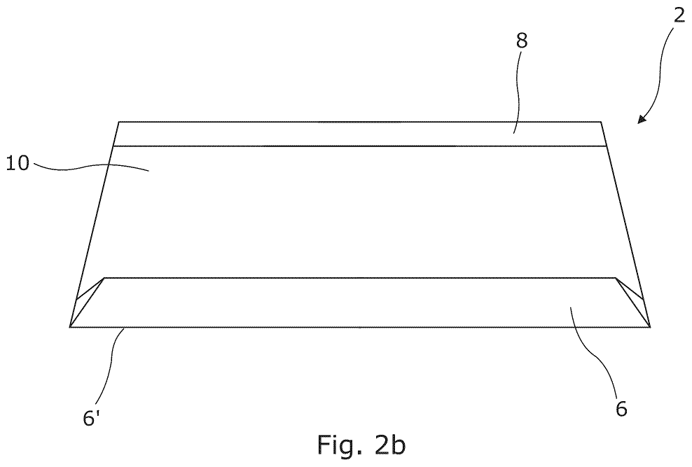

FIGS. 2a-b illustrate a front perspective and rear perspective view of the cover apparatus as illustrated in FIG. 1;

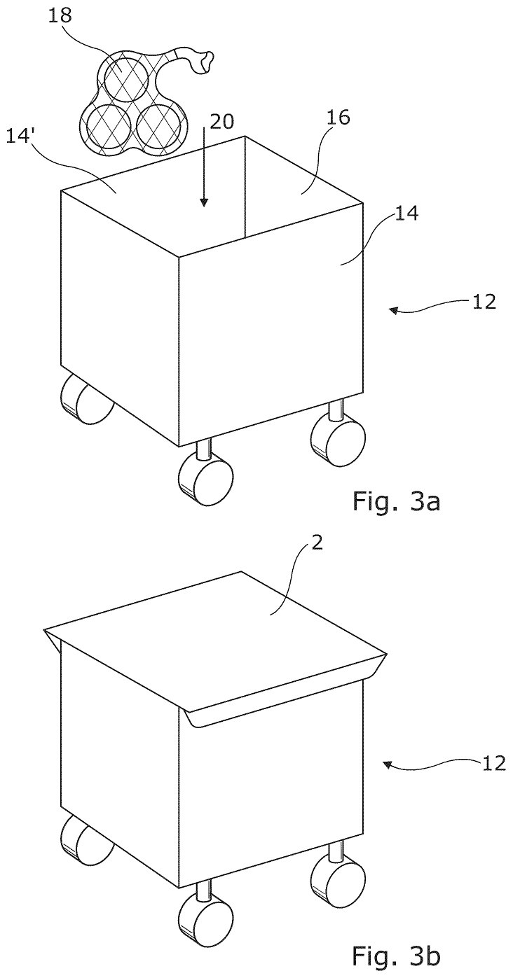

FIGS. 3a-b illustrate the steps of locating produce within a container and covering an opening of the same with a cover apparatus in accordance with the invention;

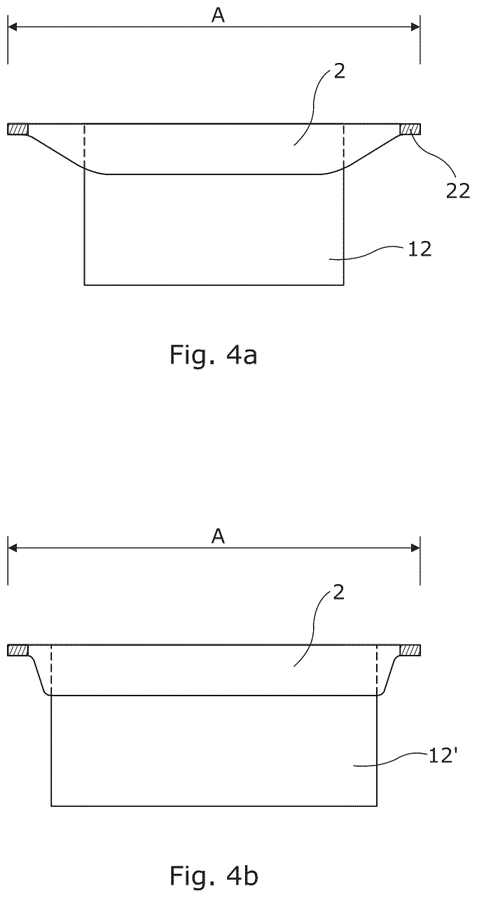

FIGS. 4a-b illustrate a cover apparatus in accordance with one embodiment of the invention located with two containers of varying lengths;

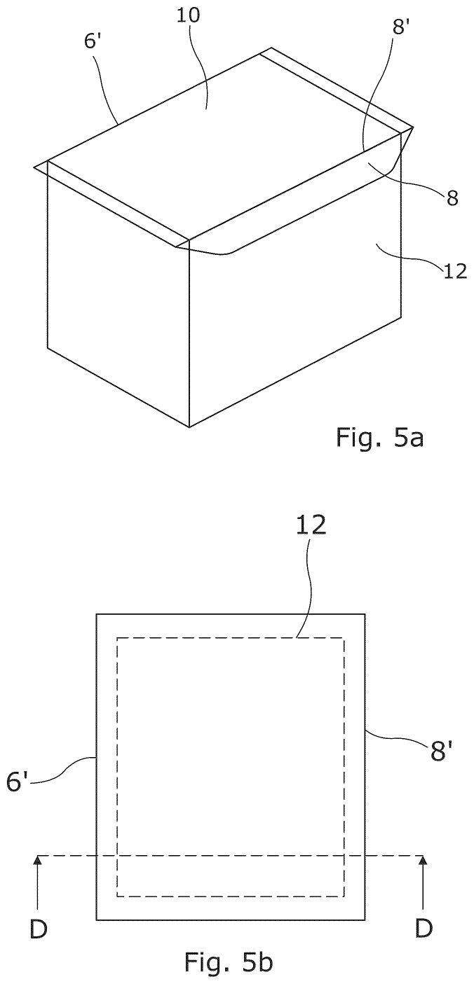

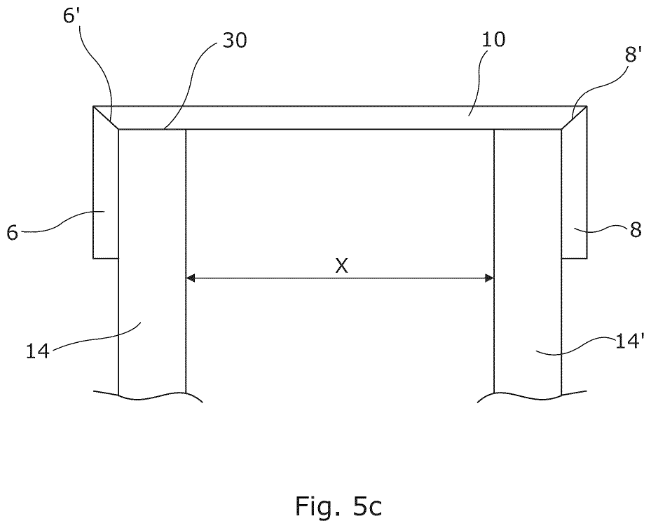

FIGS. 5a-c illustrate a perspective, top and section view of a cover apparatus in accordance with one embodiment of the invention located with a container of a first width;

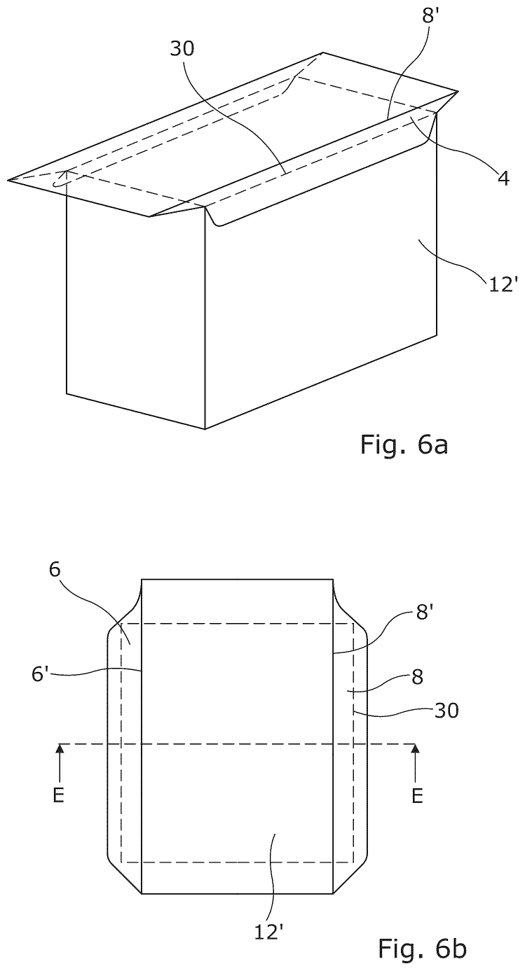

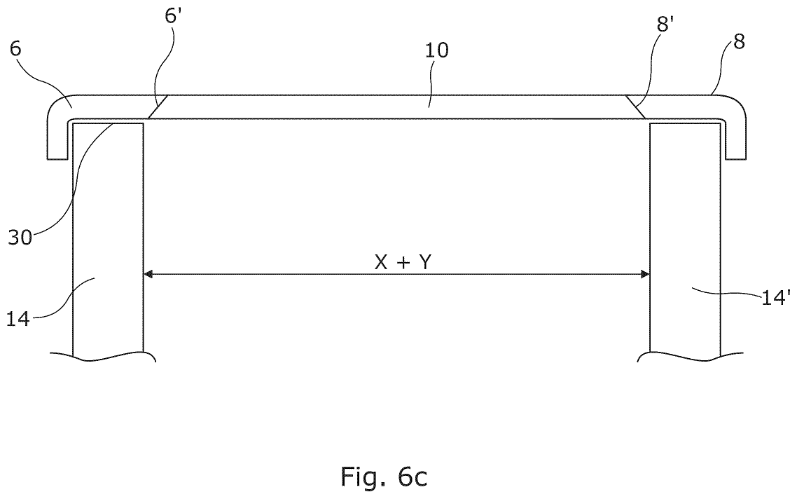

FIGS. 6a-c illustrate a perspective, top and section view of a cover apparatus in accordance with one embodiment of the invention located with a container of a second width; and

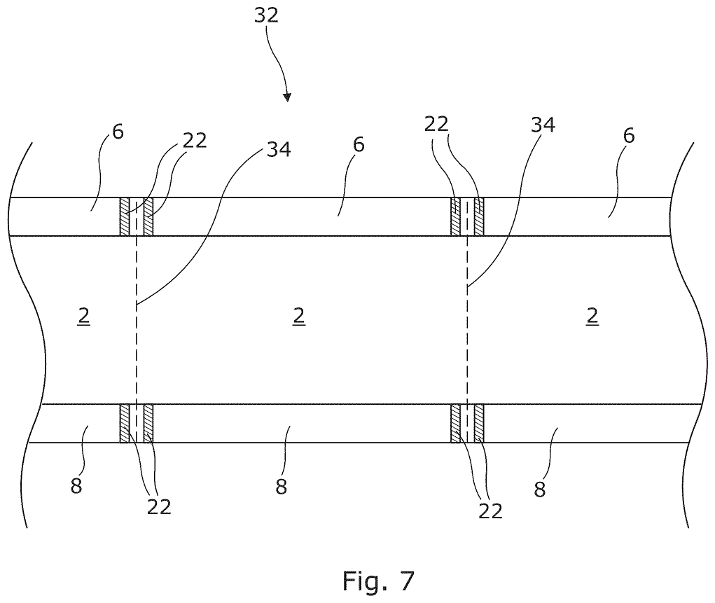

FIG. 7 illustrates a plan view of a series of cover apparatus in accordance with the invention.

Referring firstly to FIGS. 1 and 2a-b, there is illustrated a cover apparatus 2, hereafter referred to as a cover, which in this embodiment is detectable and is comprised of a flexible sheet material. In this embodiment, the flexible sheet material is a polyethylene material having a thickness of 60 microns. This thickness provides the advantage that detectable materials 4 such as metal particles embedded with the material are not able to rip or tear the same. Further, this thickness provides the advantage that welds of the material have increased strength, as the material is less likely to be damaged at the point of plastic welding. The increased thickness also increases the weight of the cover 2, ensuring that the cover will be retained in position by its own mass when located with a container, also known as a tote or dump buggy. In alternative embodiments, the cover 2 flexible sheet material may be formed of a biodegradable or recyclable material to benefit the environmental impacts of the disposal of the cover 2.

The flexible sheet material includes a number of detectable materials 4 that are integral with the same. These detectable particles include a metal alloy, including barium or magnetite, that are capable of detection by a detecting means such as an X-ray scanner or metal detecting apparatus. The detectable materials 4 are interspersed with the flexible material during the manufacture of the same. The flexible sheet material is formed of a film that is blown from polyethylene pellets. In alternative embodiments, the detectable material is suspended within a liquid phase of the material to be extruded to form the flexible sheet material. The size and density of the detectable material 4 within the flexible sheet material is selected so as to cause the detection of the detectable material 4 when the same is brought within a predetermined distance of a detecting means. In this example, the detectable material 4 particles are of a size and density to allow a 1 cm² fragment of the flexible sheet material to be detected within 1 m from an X-ray detection apparatus. The detectable material 4 is interspersed evenly throughout the flexible sheet material, however in other embodiments the density of the detectable material 4 may be increased at areas of the cover 2 that might be at greater risk of contacting consumables or detaching from the cover, such as the edges of the cover 2.

The cover 2 includes a first and second folded portion 6, 8. The folded portions 6, 8 are formed by folding a length of the flexible sheet material back across itself, such that the folded portions 6, 8 are brought into contact with the unfolded portion 10. When located with the container 12 as illustrated in FIG. 3b and FIGS. 4a-b, 5a-b and 6a-b, the folded portions 6, 8 are raised to be perpendicular to the unfolded portion 10 and located with opposing side walls 14,14′ of the tote 12. The unfolded portion 10 then extends substantially across the opening 16 of the tote 12 to cover the same. In this way, consumables 18 located through the opening 16 as illustrated by 20 in FIG. 3a are covered by the cover 2 when the cover is located with the tote 12.

In this example, the length A of the cover 2 is approximately 830 mm, the width B of the unfolded portion 10 is 665 mm, and the width of the folded portions C is 95 mm.

The folded portions 6, 8 are retained against the unfolded portion 10 by the provision of welds or seals 22. In this example, the welds or seals 22 are provided in the form of plastic welds between the folded portions 6,8 and unfolded portion 10. The welds 22 are located along the entire width of the folded portions, and are located along and proximal the opposing edges 24, 26 of the cover. The welds 22 are parallel with respect to each other and perpendicular to fold lines 6′,8′ of the folded portion. In this way, a single chamber or pouch 28 is formed by each of the folded portions. The pouches or chambers 28 are defined by the respective folded portions 6,8; respective fold lines 6′,8′; welds 22; and an adjacent part of the remainder of the sheet material cover 10. In this way, only one chamber 28 is formed by each of the folded portions 6, 8 that must be cleaned and decontaminated to removed dirt or other contaminants. Further chambers to be cleaned would otherwise be formed if the welds 22 were not located along the opposing edges 24, 26, were not parallel, or did not extend the entire width of the folded portions C. As only four weld lines 22 are required in total, there is therefore a reduced risk of a weld breaking and affecting the usage of the cover, whilst still ensuring that the cover is effective in use.

The welds 22 provide the advantage that the folded portions 6,8 are located with a friction fit against the walls of the tote 12 when the folded portions are unfolded perpendicular to the unfolded portion 10. There is no requirement for further folded portions across the width B of the cover 2. This allows for the cover 2 to be located with totes of varying lengths 12,12′ whilst maintaining a friction fit, as illustrated in FIGS. 4a-b. The maximum length of the tote to be covered is defined by the distance A between the welds 22. As illustrated in FIGS. 5a-b, and FIG. 5c which is a section view along line D-D of FIG. 5b, the width X of the tote 12 may be within the fold lines 6′,8′ of the cover 2 and the length C of the folded portions 6, 8 may be located with the walls 14,14′ of the container. FIGS. 6a-b, and FIG. 6c which is a section view along line E-E of FIG. 6b, illustrate a tote 12′ with a greater width X+Y that extends beyond the width of the portion 10 of cover 2 but can still be covered by the cover 2 as the walls 14,14′ of the container are located with the cover outwardly from the respective fold lines 6′,8′. However, due to the provision of the welds 22 a pouch is still formed at each edge which is of a sufficient size to exert a friction fit of the cover with the side walls 14,14′ and retain the cover in position.

Referring to FIG. 7, there is illustrated a series of covers 2 as provided by the cover manufacturer. The covers 2 are provided as a roll 32 with each cover attached to the next by a line of weakening 34 such that each cover may be torn from the roll along the line of weakening. In this embodiment, the line of weaking 34 is created by perforating the width of the roll 32. Seals 22 are located on either side of the line of weakening 34. In this way, a plurality of covers 2 may be manufactured from a single film of sheet material that is then perforated and sealed.

Thus, there is provided a cover 2 that may be retained by friction fit with a tote 12 by only two opposing folded portions 6, 8. This provides the advantage that one cover 2 may be fitted with totes 12 of varying lengths. The cover 2 is formed of a flexible sheet material that is resistant to tears and includes detectable material 4 integrally formed with the same. When the consumable goods 18 located within the totes 12 are inspected before being transported to the end consumer, they are passed through a detecting means such as an X-ray detection apparatus. If a cover 2 has fallen within the totes 12 or a part of the cover 2 has torn off and has come into contact with the consumables, the detectable material 4 will be visible to the detecting apparatus and will be alerted to the operator of the detecting apparatus before the consumables are made available to the end consumer. The contaminated consumables may then be removed and disposed.

1. A cover apparatus for an opening of a container, the cover apparatus comprising:
a flexible sheet material and including first and second folded portions respectively located adjacent to opposing edges of, and co-planar with, a remainder of the said cover apparatus, and each said folded portion capable of being at least partially unfolded to be moved, when the cover apparatus is located over the opening of the container, to a position to contact with an adjacent side wall of the container such that the opening of the container is substantially covered by the remainder of the cover apparatus; and
wherein the said folded portions of the cover apparatus are retained so as to be substantially co-planar with the remainder of the cover apparatus and, when the said respective folded portions are at least partially unfolded, to form a chamber or pouch, by the provision of first and second seals or welds located at opposing ends of each respective folded portion.

2. The cover apparatus according to claim 1, wherein the flexible sheet material includes one or more detectable materials as an integral part thereof that render the cover apparatus detectable by X-ray and/or metal detection apparatus when in range thereof so as to allow the presence of the cover apparatus, or a fragment of the cover apparatus greater than a predetermined size, to be detectable.

3. The cover apparatus according to claim 2, wherein the detectable material includes particles of a metal or a metal alloy of a form which is capable of detection by metal detection apparatus.

4. The cover apparatus according to claim 2 wherein the detectable material includes any or any combination of barium, magnetite and/or iodine to render the cover apparatus capable of detection by X-ray detection apparatus.

5. The cover apparatus according to claim 2, wherein a density of the detectable material which is included in the flexible sheet material is selected with respect to the predetermined size of fragment of the cover apparatus which is desired to be detectable when in a predetermined range of detection apparatus.

6. The cover apparatus according to claim 1, wherein the said first and second seals or welds are substantially parallel to each other, and perpendicular to a fold line of the folded portion such that the first and second seals or welds and said folded portion when at least partially unfolded, define the said pouch or chamber.

7. The cover apparatus according to claim 1, wherein the seals or welds are located at opposing ends of the folded portion and the depth of the folded portion is predetermined to suit the dimensions of the range of container sizes with which the cover apparatus is designed to be located.

8. The cover apparatus according to claim 1, wherein the thickness of the flexible sheet material is between 34 and 70 microns.

9. The cover apparatus according to claim 1, wherein the flexible sheet material is provided in a colour associated with a particular indication, such as the origin or destination locations for a container with which the cover apparatus is located, the contents of a container with which the cover apparatus is located or the time in which the cover apparatus was located with a container.

10. The cover apparatus according to claim 1, wherein the flexible sheet material is formed by blowing polymer pellets into a film.

11. The cover apparatus according to claim 1, wherein the flexible sheet material is formed from a material which is compostable and/or biodegradable.

12. The cover apparatus according to claim 1, wherein a series of cover apparatus is provided in a roll supply and the respective cover apparatus are defined by lines of weakening formed across the roll supply so that the leading cover apparatus can be detached for use by tearing a line of weakening.

13. A container and cover apparatus assembly, the assembly including a container with sidewalls, a base and an opening for the placement of goods therethrough, and a cover apparatus comprised of a flexible sheet material and including at least first and second folded portions for location along respective opposing sidewalls of the container such that a remainder of the cover apparatus substantially extends across the opening of the container, wherein when the said first and second folded portions are at least partially unfolded they form a chamber or pouch by the provision of first and second seals or welds located at opposing ends of each respective folded sheet material portion.

14. The container and cover apparatus assembly according to claim 13, wherein the flexible sheet material includes one or more detectable materials as an integral part thereof that are detectable by X-ray and/or metal detection apparatus so as to allow the presence of the cover apparatus, or a fragment of the cover apparatus greater than a predetermined size, to be detectable by metal and/or X-ray detection apparatus.

15. The container and cover apparatus assembly according to claim 13, wherein the geometry of the cover apparatus is such that the cover apparatus is located with the container by friction fit.
